(19) United States
(12) Patent Application Publication
(10) Pub. No.: US 2026/0074453 A1
(43) Pub. Date: Mar. 12, 2026

(54) WIRE HARNESS

(71) Applicant: YAZAKI CORPORATION, Tokyo (JP)

(72) Inventors: Mitsuhisa Sano, Susono-shi (JP); Taku Furuta, Makinohara-shi (JP); Kenichi Imou, Makinohara-shi (JP); Junya Kato, Makinohara-shi (JP); Hiroki Suganuma, Makinohara-shi (JP)

(21) Appl. No.: 19/324,192

(22) Filed: Sep. 10, 2025

(30) Foreign Application Priority Data
Sep. 11, 2024 (JP) 2024-157110

(51) Int. Cl. H01R 12/77

(52) U.S. Cl. CPC H01R 12/778; H01R 12/774; H01R 2201/26

(57) ABSTRACT

A wire harness includes a flat routing member having flexibility, a connector that is mounted on a surface of the flat routing member and is fitted and connected to an electronic device along a fitting direction intersecting the surface, and a terminal-equipped electric wire that includes a terminal accommodated in a housing of the connector and electrically connected to the electronic device and an electric wire having one end electrically connected to the terminal and another end electrically connected to the flat routing member, and is interposed between the flat routing member and the connector.

### CROSS-REFERENCE TO RELATED APPLICATION(S)

The present application claims priority to and incorporates by reference the entire contents of Japanese Patent Application No. 2024-157110 filed in Japan on Sep. 11, 2024.

### BACKGROUND OF THE INVENTION

### 1. Field of the Invention

The present invention relates to a wire harness.

### 2. Description of the Related Art

As a technique related to a conventional wire harness, for example, Japanese Patent Application Laid-open No. JP 2004-296 294 A discloses a wire harness including a flexible flat routing member and a connector mounted on a surface of the flat routing member and fitted and connected to an electronic device along a fitting direction intersecting the surface.

Meanwhile, in the wire harness described in Japanese Patent Application Laid-open No. JP 2004-296 294 above, for example, the connector is fixed on the surface of the flat routing member, and the wire harness has room for further improvement in terms of the workability of the connection work between the connector and the electronic device.

### SUMMARY OF THE INVENTION

The present invention has been made in view of the above circumstances, and an object of the present invention is to provide a wire harness capable of improving the workability of connection work.

In order to achieve the above mentioned object, a wire harness according to one aspect of the present invention includes a flat routing member having flexibility; a connector that is mounted on a surface of the flat routing member and is fitted and connected to an electronic device along a fitting direction intersecting the surface; and a terminal-equipped electric wire that includes a terminal accommodated in a housing of the connector and electrically connected to the electronic device and an electric wire having one end electrically connected to the terminal and another end electrically connected to the flat routing member, and is interposed between the flat routing member and the connector.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary plan view of a wire harness according to an embodiment;

FIG. 2 is an exemplary cross-sectional view of the wire harness according to the embodiment;

FIG. 3 is an exemplary schematic perspective view (partial cross-sectional view) of the wire harness according to the embodiment;

FIG. 4 is an exemplary cross-sectional view of the wire harness according to the embodiment, and is a view illustrating a state before connection in which a connector is deviated toward one end in the width direction with respect to an electronic device;

FIG. 5 is an exemplary cross-sectional view of the wire harness according to the embodiment, and is a view illustrating a state after connection in which the positional deviation of the connector with respect to the electronic device is absorbed;

FIG. 6 is an exemplary cross-sectional view of the wire harness according to the embodiment, and is a view illustrating a state before connection in which the connector is deviated toward the other end in the width direction with respect to the electronic device;

FIG. 7 is an exemplary cross-sectional view of the wire harness according to the embodiment, and is a view illustrating a state after connection in which the positional deviation of the connector with respect to the electronic device is absorbed;

FIG. 8 is an exemplary perspective view of a wire harness according to a modification;

FIG. 9 is an exemplary exploded perspective view of the wire harness according to the modification; and

FIG. 10 is an exemplary cross-sectional view of the wire harness according to the modification.

### DETAILED DESCRIPTION OF THE PREFERRED EMBODIMENTS

Hereinafter, an embodiment according to the present invention and a modification thereto will be described in detail with reference to the drawings. Note that the present invention is not limited to the following embodiment and modification. In addition, constituent elements in the following embodiment and modification include those that can be easily replaced by those skilled in the art or those that are substantially the same.

In addition, the embodiment and modification disclosed below include similar constituent elements. Therefore, in the following description, common reference numerals are given to the similar constituent elements, and redundant description is omitted. In the present specification, ordinal numbers are used only to distinguish components, members, parts, positions, directions, and the like, and they do not indicate order or priority.

### Embodiment

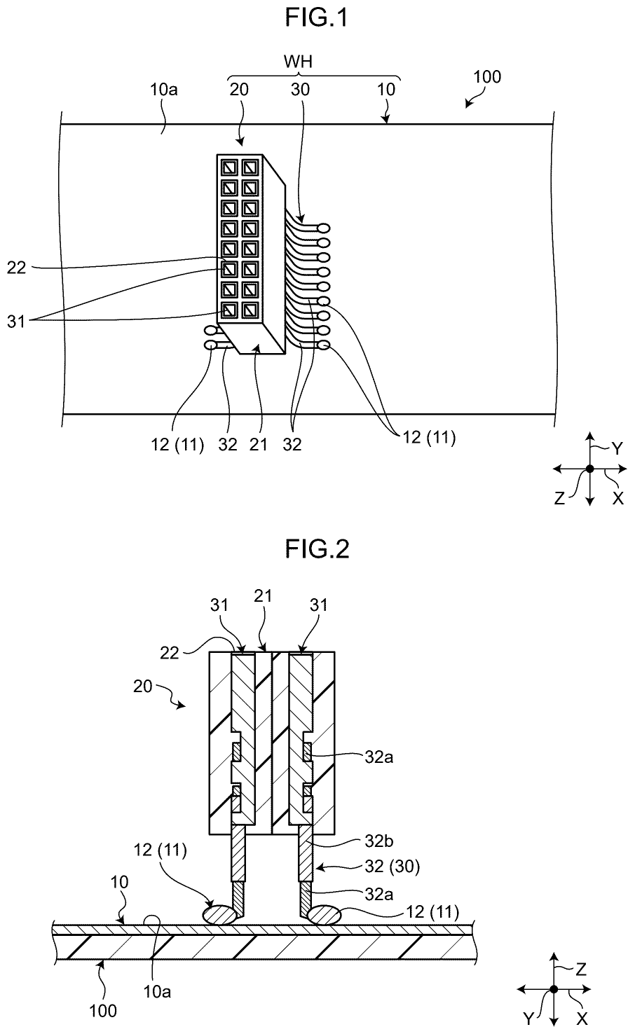

FIG. 1 is a plan view of a wire harness WH according to an embodiment. The wire harness WH of the present embodiment illustrated in FIG. 1 is applied to a vehicle, and is used for power supply and signal communication by connecting devices mounted in the vehicle. The wire harness WH of the present embodiment includes, for example, a flat routing member 10, a connector 20, and a terminal-equipped electric wire 30. The wire harness WH is provided, for example, on a mounting panel 100 of the vehicle and is routed along the mounting panel 100. The mounting panel 100 is a dash panel or the like that separates the engine room of the vehicle and the vehicle interior (cabin), and constitutes a structural member (frame member) of the vehicle. The wire harness WH may further include various components such as a fixture, a protector, and a grommet.

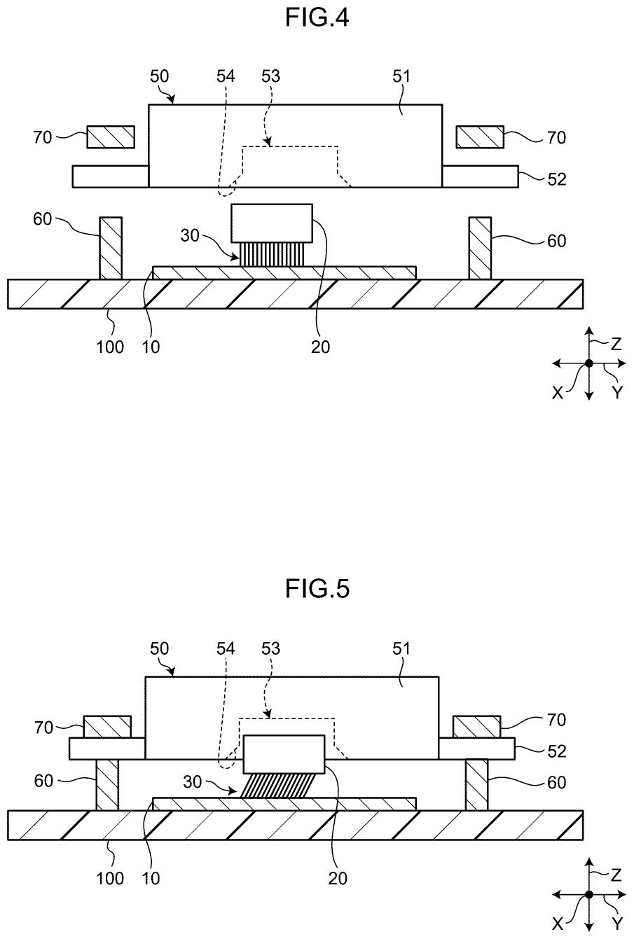

In the following description, among a first direction, a second direction, and a third direction intersecting, the first direction is referred to as an “extending direction X”, the second direction is referred to as a “width direction Y”, and the third direction is referred to as a “fitting direction Z”. Here, the extending direction X, the width direction Y, and the fitting direction Z are substantially orthogonal to each other. The extending direction X typically corresponds to the longitudinal direction or the like of the wire harness WH and the flat routing member 10. The width direction Y typically corresponds to the width direction (lateral direction) or the like of the wire harness WH and the flat routing member 10. The fitting direction Z typically corresponds to a vertical direction (plate thickness direction) of the wire harness WH and the flat routing member 10, a fitting direction (connection direction) between the connector 20 and an electronic device 50 (see FIG. 4), and the like. Each direction used in the following description will be explained as a direction in a state where the wire harness WH is assembled to the vehicle unless otherwise specified.

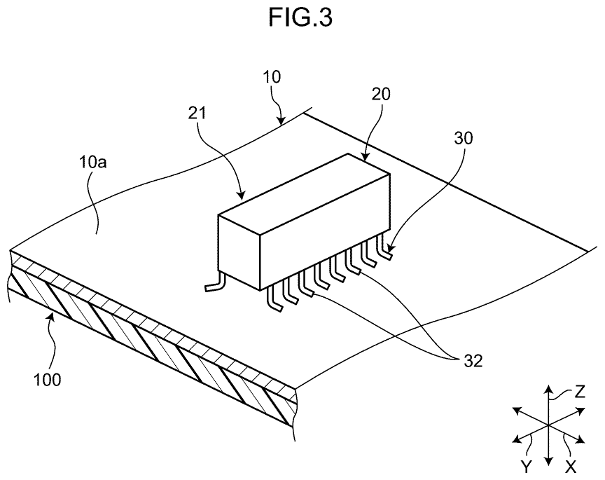

FIG. 2 is a cross-sectional view of the wire harness WH, and FIG. 3 is a schematic perspective view (partial cross-sectional view) of the wire harness WH. As illustrated in FIGS. 2 and 3, the flat routing member 10 is a routing member constituting the wire harness WH, and is configured with, for example, a flexible printed circuit (FPC), a flexible flat cable (FFC), or the like. The flat routing member 10 is formed, as a whole, in a horizontally long rectangular plate shape along the extending direction X. The flat routing member 10 is a flat routing member which is thin along the fitting direction Z and has flexibility (bendability).

The flat routing member 10 includes, for example, a base film, a wiring pattern, and a coverlay. The base film is a base material having excellent flexibility and defining the entire shape of the flat routing member 10.

The base film is made of, for example, a polyimide resin or the like having excellent heat resistance. The wiring pattern is laminated on the surface of the base film to constitute a plurality of conductor circuit portions (pattern layers). The wiring pattern is made of, for example, a conductive material such as copper foil, and is printed as a printed circuit body on the surface of the base film. The coverlay is laminated on the surface of the base film with an adhesive or the like interposed therebetween, and functions as a protective layer for protecting the conductor circuit portions or the like of the wiring pattern. In the present embodiment, for example, at least a part of the wiring pattern is exposed from the coverlay on a surface 10a of the flat routing member 10, and the exposed part is electrically connected to the terminal-equipped electric wire 30 via a solder joint 12.

The connector 20 is mounted on the surface 10a of the flat routing member 10 and is to be fitted and connected to a mating connector 53 (see FIG. 4) of the electronic device 50 along the fitting direction Z. The connector 20 includes, for example, a housing 21 and a plurality of terminals 31 (see FIG. 2) accommodated in the housing 21.

The housing 21 is formed in, for example, a flat rectangular tubular shape along the extending direction X. The housing 21 is provided with a plurality of cavities 22 into which the plurality of terminals 31 is inserted along the fitting direction Z. The plurality of cavities 22 is provided at intervals along the extending direction X and the width direction Y in the housing 21.

The connector 20 is electrically connected to the wiring pattern of the flat routing member 10 via the terminal-equipped electric wire 30. The plurality of conductor circuit portions configured with the wiring pattern can function as any circuit such as a signal circuit, a signal GND circuit, or a power ground circuit. The signal circuit is, for example, a circuit that transmits a communication signal between the electronic device 50 and in-vehicle devices such as various electronic devices in the vehicle. The signal GND circuit is a circuit that accompanies the signal circuit, establishes electrical conductivity between in-vehicle devices, and adjusts a potential serving as the reference for a circuit operation among the in-vehicle devices. The power ground circuit is a circuit that grounds a power supply system of the in-vehicle devices.

The terminal-equipped electric wire 30 constitutes the terminals 31 of the connector 20 and electrically connects the terminals 31 and the flat routing member 10. In the present embodiment, a plurality of terminal-equipped electric wires 30 is provided corresponding to the plurality of cavities 22 of the connector 20. Each of the terminal-equipped electric wires 30 includes the terminal 31 and an electric wire 32. The terminal 31 is, for example, a male terminal fitting made of a conductive metal material, and is to be electrically connected to a mating terminal of the mating connector 53. The terminal 31 includes, for example, an electrical connection portion that is to be electrically connected to the mating terminal and a wire crimping portion electrically connected to one terminal (conductor portion 32a) of the electric wire 32.

The electric wire 32 includes a linear conductor portion 32a having conductivity and an insulation sheath 32b that has an insulation property and covers the outside of the conductor portion 32a. The electric wire 32 is an insulated electric wire in which the conductor portion 32a is covered with the insulation sheath 32b. The conductor portion 32a of the present embodiment is a core wire in which a plurality of conductive metal wires is bundled, but may be a stranded core wire obtained by twisting the plurality of metal wires. The insulation sheath 32b is an electric wire cover that covers the outer peripheral side of the conductor portion 32a. The insulation sheath 32b is formed by, for example, extruding an insulating resin material or the like.

The electric wires 32 extend linearly along the fitting direction Z and are formed to extend with substantially the same diameter with respect to the fitting direction Z (extending direction). In each electric wire 32, for example, a cross-sectional shape of the conductor portion 32a (cross-sectional shape intersecting the fitting direction Z) is formed in a substantially circular shape, a cross-sectional shape of the insulation sheath 32b is formed in a substantially annular shape, and each electric wire 32 is formed in a substantially circular cross-sectional shape as a whole. In each electric wire 32, the insulation sheath 32b is peeled off at both ends thereof in the fitting direction Z, and the conductor portion 32a is exposed from the insulation sheath 32b. Then, the conductor portion 32a exposed at one end of the electric wire 32 is electrically connected to the terminal 31, and the conductor portion 32a exposed at the other end of the electric wire 32 is electrically connected to the flat routing member 10 via the solder joint 12.

Here, in the present embodiment, the flat routing member 10 and the housing 21 of the connector 20 are spaced from each other along the fitting direction Z, and the terminal-equipped electric wire 30 is interposed so as to extend between the flat routing member 10 and the connector 20. The electric wires 32 of the terminal-equipped electric wire 30 can be deformed (bent) in a direction intersecting the fitting direction Z, that is, along the extending direction X and the width direction Y, and allow displacement of the connector 20 with respect to the flat routing member 10 along the extending direction X and the width direction Y. That is, when the electronic device 50 (see FIGS. 4 and 5), described later, and the connector 20 are fitted and connected to each other, the electric wires 32 of the terminal-equipped electric wire 30 are deformed (bent), which allows the terminal-equipped electric wire 30 to follow the movement of the connector 20. The connector 20 is disposed on the surface 10a of the flat routing member 10 in a standby state with respect to the electronic device 50.

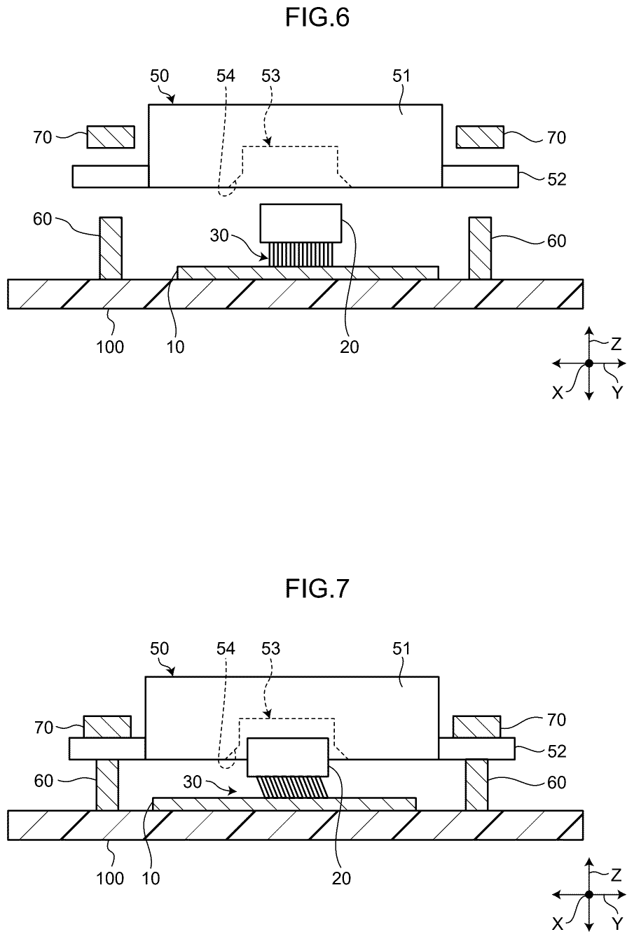

FIG. 4 is a cross-sectional view of the wire harness WH, illustrating a state before connection in which the connector 20 is deviated toward one end in the width direction Y with respect to the electronic device 50, and FIG. 5 is a cross-sectional view of the wire harness WH, illustrating a state after connection in which the positional deviation of the connector 20 with respect to the electronic device 50 is absorbed. FIG. 6 is a cross-sectional view of the wire harness WH, illustrating a state before connection in which the connector 20 is deviated toward the other end in the width direction Y with respect to the electronic device 50, and FIG. 7 is a cross-sectional view of the wire harness WH, illustrating a state after connection in which the positional deviation of the connector 20 with respect to the electronic device 50 is absorbed.

As illustrated in FIGS. 4 to 7, the electronic device 50 includes, for example, a casing 51, a flange 52, the mating connector 53, and a tapered surface 54. The flanges 52 are provided at both ends in the width direction Y of the casing 51, and protrude from the both ends toward the side away from each other along the width direction Y. The flanges 52 are each provided with an insertion hole through which a fastening member 60 such as a bolt for fastening the mounting panel 100 of the vehicle and the electronic device 50 to each other is inserted along the fitting direction Z. The fastening member 60 is fastened to a fastening member 70 such as a nut in a state of being inserted into the insertion hole of the flange 52.

For example, the mating connector 53 is formed in a recessed shape on the bottom wall of the casing 51. The mating connector 53 includes a mating terminal that is to be electrically connected to the terminal 31 of the connector 20. The mating terminal is configured with, for example, a female terminal fitting made of a conductive metal material. The tapered surface 54 is provided at the open end of the mating connector 53. The tapered surface 54 is inclined toward both sides in the width direction Y and both sides in the extending direction X as the tapered surface 54 extends toward the connector 20 along the fitting direction Z. In the present embodiment, the tapered surface 54 having such a shape enhances the insertability of the connector 20 into the mating connector 53.

Here, in the present embodiment, the connector 20 is fitted to the mating connector 53 on the electronic device 50 side along the fitting direction Z as the electronic device 50 is fastened to the mounting panel 100 of the vehicle by the fastening members 60 and 70. Specifically, in the present embodiment, the fastening member 60 is provided in a state of protruding from the mounting panel 100 toward the electronic device 50 along the fitting direction Z, and is fastened to the fastening member 70 in a state of being inserted through a through hole formed in the flange 52 described above. As a result, the fastening members 60 and 70 function as assist bolts at the time of fitting the connector 20 and the mating connector 53 on the electronic device 50 side, and eventually, the fitting work between the connector 20 and the mating connector 53 can be performed more easily or more smoothly.

At this time, in the present embodiment, displacement along the width direction Y and the extending direction X intersecting the fitting direction Z of the connector 20 with respect to the flat routing member 10 is allowed due to the electric wires 32 of the terminal-equipped electric wire 30 interposed between the flat routing member 10 and the connector 20. Therefore, in the present embodiment, the connector 20 moves relative to the flat routing member 10 at the time of fitting the connector 20 and the mating connector 53, so that it is possible to absorb the positional deviation between the connector 20 and the mating connector 53 along the width direction Y and the extending direction X.

As described above, in the wire harness WH of the present embodiment, the terminal-equipped electric wire 30 includes the terminal 31 that is accommodated in the housing 21 of the connector 20 and is to be connected electrically to the electronic device 50, and the electric wire 32 having one end electrically connected to the terminal 31 and the other end electrically connected to the flat routing member 10, and the terminal-equipped electric wire 30 is interposed between the flat routing member 10 and the connector 20. With this configuration, the wire harness WH allows displacement along the extending direction X and the width direction Y intersecting the fitting direction Z of the connector 20 with respect to the flat routing member 10 by the electric wires 32 of the terminal-equipped electric wire 30, for example, and further, can absorb the positional deviation (tolerance) along the extending direction X and the width direction Y of the connector 20 with respect to the electronic device 50. As a result, the wire harness WH can improve the workability of the connection work.

In the wire harness WH of the present embodiment, the flat routing member 10 is routed along the mounting panel 100 of the vehicle, and the connector 20 is fitted to the mating connector 53 on the electronic device 50 side along the fitting direction Z in response to the fastening of the electronic device 50 to the mounting panel 100 by the fastening members 60 and 70. With this configuration, for example, in a case where the electronic device 50 is fastened and fixed to the mounting panel 100 of the vehicle by the fastening members 60 and 70, the wire harness WH can absorb the positional deviation (tolerance) along the extending direction X and the width direction Y of the connector 20 with respect to the electronic device 50 by the electric wires 32 of the terminal-equipped electric wire 30. As a result, the wire harness WH can further improve the workability of the connection work.

### Modification

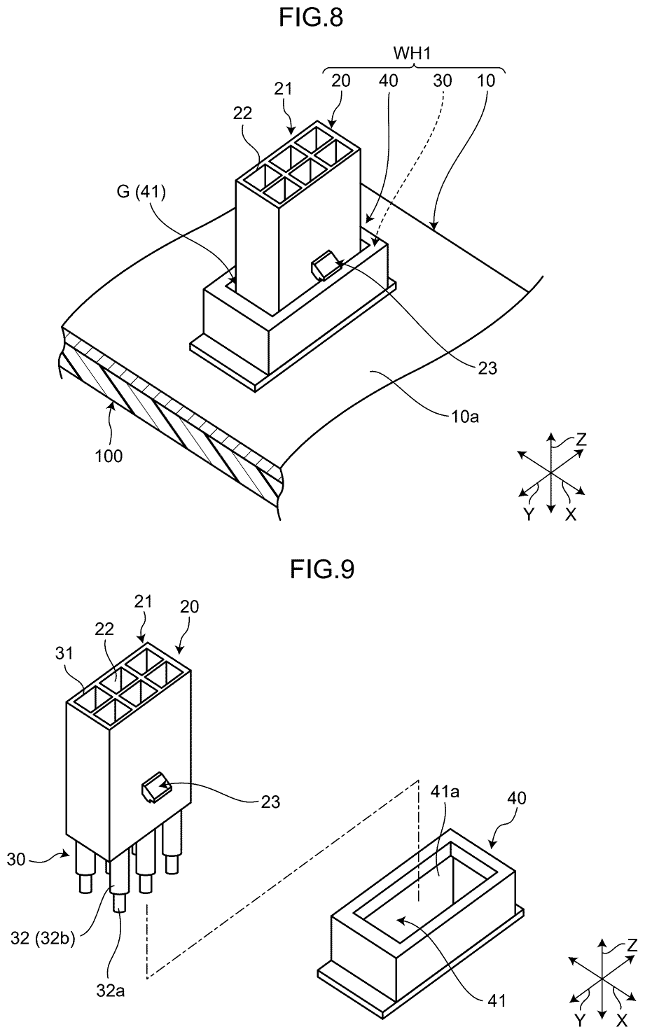

FIG. 8 is a perspective view of a wire harness WH1 according to a modification. The wire harness WH1 illustrated in FIG. 8 has a configuration similar to that of the wire harness WH of the above embodiment. Thus, the wire harness WH1 can achieve similar operation and effect to those of the above embodiment based on the similar configuration.

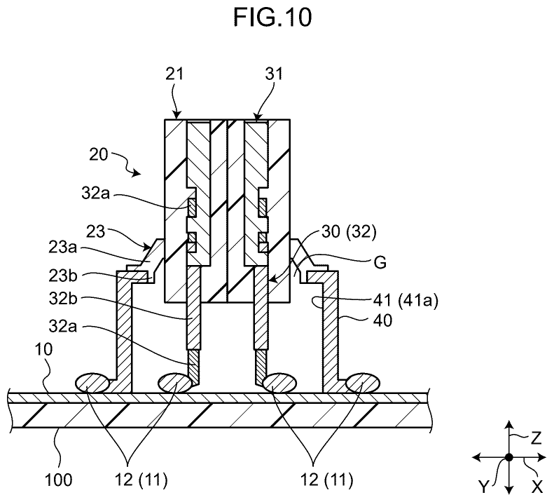

However, as illustrated in FIG. 8, the present modification is different from the above-described embodiment in that a protective member 40 shielding the periphery of the connector 20 and the terminal-equipped electric wire 30 is provided. The protective member 40 shields and protects the connector 20 and the terminal-equipped electric wire 30 from both sides in the extending direction X and both sides in the width direction Y. The protective member 40 is provided with an opening 41 into which the connector 20 and the terminal-equipped electric wire 30 are inserted along the fitting direction Z. The protective member 40 is formed in, for example, a rectangular tubular shape along the outer peripheral surface of the housing 21 of the connector 20. The protective member 40 is mounted on the surface 10a of the flat routing member 10, and is fixed to the flat routing member 10 via the solder joint 12 (see FIG. 10) or the like.

FIG. 9 is an exploded perspective view of the wire harness WH1, and FIG. 10 is a cross-sectional view of the wire harness WH1. As illustrated in FIGS. 9 and 10, in the present modification, a gap G is provided between an inner surface 41a of the opening 41 and the connector 20. The gap G allows relative movement of the connector 20 with respect to the protective member 40 along the extending direction X and the width direction Y. The gap G is configured with, for example, a rectangular opening that is along the outer peripheral surface of the housing 21 of the connector 20 and is slightly larger than the outer peripheral surface.

A locking portion 23 to be locked to the protective member 40 is provided on the outer peripheral surface of the housing 21. In the present modification, the locking portion 23 is provided at each end in the extending direction X of the housing 21, and protrudes in a cantilever spring shape from the outer peripheral surface of the housing 21 toward the protective member 40. Each of the locking portions 23 making a pair includes an arm portion 23a and a claw portion 23b, and is elastically deformably locked to the inner surface 41a of the opening 41 along the extending direction X.

For example, the arm portions 23a making a pair are formed at positions facing each other with the housing 21 interposed therebetween in the extending direction X. The pair of arm portions 23a is formed in an arm shape (umbrella shape) protruding from the outer peripheral surface of the housing 21 along the fitting direction Z and inclined so as to gradually spread toward both sides in the extending direction X as it extends toward the protective member 40 along the fitting direction Z. That is, the pair of arm portions 23a is configured such that one end thereof in the fitting direction Z is coupled to the outer peripheral surface of the housing 21, and the other end thereof in the fitting direction Z is a free end elastically deformable along the extending direction X.

The pair of claw portions 23b is provided, for example, at the distal ends of the pair of arm portions 23a, and is formed in a claw shape to be locked to the inner surface 41a of the opening 41 and the upper surface of the protective member 40. The pair of claw portions 23b has, for example, a substantially L-shaped cross-sectional shape opened toward the peripheral edge of the opening 41. In the present modification, the pair of claw portions 23b and the inner surface 41a of the opening 41 are elastically deformably locked along the extending direction X, so that the relative movement of the connector 20 with respect to the protective member 40 along the extending direction X is allowed.

As described above, the wire harness WH1 of the present modification includes the protective member 40 provided with the opening 41 into which the connector 20 and the terminal-equipped electric wire 30 are inserted along the fitting direction Z, and the gap G that allows the relative movement of the connector 20 along the extending direction X and the width direction Y intersecting the fitting direction Z with respect to the protective member 40 is provided between the inner surface 41a of the opening 41 and the connector 20. With this configuration, for example, the wire harness WH1 can protect the connector 20 and the terminal-equipped electric wire 30 while absorbing the positional deviation (tolerance) along the extending direction X and the width direction Y of the connector 20 with respect to the electronic device 50 due to the gap G of the protective member 40.

In the wire harness WH1 of the present modification, the connector 20 has the locking portion 23 that protrudes in a cantilever spring shape toward the protective member 40 and is elastically deformably locked to the inner surface 41a of the opening 41 along the extending direction X. With this configuration, the wire harness WH1 allows, for example, the relative movement of the connector 20 with respect to the protective member 40 along the extending direction X due to the locking portion 23, and further can reduce the interference between the housing 21 of the connector 20 and the protective member 40 due to the relative movement.

In the present modification, the case where the locking portion 23 is provided at each end in the extending direction X of the connector 20 has been exemplified, but the present invention is not limited to this example, and the locking portion 23 may be provided at each end in the width direction Y of the connector 20 for example. In this case, the locking portion 23 can be elastically deformably locked to the inner surface 41a of the opening 41 along the width direction Y. Further, for example, the locking portion 23 may be provided at each end in the extending direction X of the connector 20 and at each end in the width direction Y of the connector 20. For example, the connector 20 does not necessarily have to be fitted to the mating connector 53 on the electronic device 50 side at the time of fastening the electronic device 50 to the mounting panel 100 by the fastening members 60 and 70.

Although the embodiment and the modification of the present invention have been exemplified above, the embodiment and the modification are merely examples, and are not intended to limit the scope of the invention. The above-described embodiments and modifications can be implemented in various other forms, and various omissions, substitutions, combinations, and changes can be made without departing from the gist of the invention. In addition, specifications (Structure, type, direction, form, size, length, width, thickness, height, number, arrangement, position, material, and the like) of each configuration, shape, and the like can be appropriately changed and implemented.

In a wire harness according to the present embodiments and modifications, a terminal-equipped electric wire includes a terminal that is accommodated in a housing of a connector and is electrically connected to an electronic device and an electric wire having one end electrically connected to the terminal and another end electrically connected to the flat routing member, and the terminal-equipped electric wire is interposed between the flat routing member and the connector. With this configuration, the wire harness allows displacement along the direction intersecting the fitting direction of the connector with respect to the flat routing member by the electric wire of the terminal-equipped electric wire, for example, and further, can absorb the positional deviation (tolerance) along the direction intersecting the fitting direction of the connector with respect to the electronic device. As a result, the wire harness produces the effect of improving the workability of the connection work.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a flat routing member having flexibility;
a connector that is mounted on a surface of the flat routing member and is fitted and connected to an electronic device along a fitting direction intersecting the surface; and
a terminal-equipped electric wire that includes a terminal accommodated in a housing of the connector and electrically connected to the electronic device and an electric wire having one end electrically connected to the terminal and another end electrically connected to the flat routing member, and is interposed between the flat routing member and the connector.

2. The wire harness according to claim 1, wherein
the flat routing member is routed along a mounting panel of a vehicle, and
the connector is fitted to a mating connector on the electronic device side along the fitting direction in response to fastening of the electronic device to the mounting panel by a fastening member.

3. The wire harness according to claim 1, further comprising:
a protective member including an opening into which the connector and the terminal-equipped electric wire are inserted along the fitting direction, wherein
a gap is provided between an inner surface of the opening and the connector, the gap allowing relative movement of the connector along a direction intersecting the fitting direction with respect to the protective member.

4. The wire harness according to claim 2, further comprising:
a protective member including an opening into which the connector and the terminal-equipped electric wire are inserted along the fitting direction, wherein
a gap is provided between an inner surface of the opening and the connector, the gap allowing relative movement of the connector along a direction intersecting the fitting direction with respect to the protective member.

5. The wire harness according to claim 3, wherein
the connector includes a locking portion that protrudes in a cantilever spring shape toward the protective member and is elastically deformably locked to the inner surface of the opening along the intersecting direction.

6. The wire harness according to claim 4, wherein
the connector includes a locking portion that protrudes in a cantilever spring shape toward the protective member and is elastically deformably locked to the inner surface of the opening along the intersecting direction.
